(19) United States
(12) Patent Application Publication
(10) Pub. No.: US 2026/0158753 A1
(43) Pub. Date: Jun. 11, 2026

(54) THERMOPLASTIC REPAIR PATCHES AND METHODS OF USE

(71) Applicant: The Boeing Company, Arlington, VA (US)

(72) Inventors: Phillip John Crothers, Hampton East (AU); Ying Shi, Maryland Heights, MO (US); Alexander Michael Rubin, St. Louis, MO (US)

(21) Appl. No.: 18/970,359

(22) Filed: Dec. 5, 2024

(51) Int. Cl. B29C 73/10; B29K 101/12; B29L 31/30

(52) U.S. Cl. CPC B29C 73/10; B29K 2101/12; B29K 2995/0012; B29L 2031/3076

(57) ABSTRACT

A thermoplastic part with a thermoplastic repair patch and methods of repairing a thermoplastic part are presented. The thermoplastic part with a thermoplastic repair patch comprises a composite material with a cut-out forming a repair area, and the thermoplastic repair patch in the cut-out. The composite material has a first melting temperature. The thermoplastic repair patch comprises a plurality of consolidated thermoplastic stacks, each consolidated thermoplastic stack comprising thermoplastic composite plies between low melt thermoplastic surfaces having a second melting temperature lower than the first melting temperature.

### BACKGROUND INFORMATION

### 1. Field

The present disclosure relates generally to thermoplastic materials and more specifically to thermoplastic repair.

### 2. Background

Repair of large thermoplastic parts is undesirably difficult for aerospace structural repair. Existing thermoplastic repair processes involve the secondary bonding or bolting of dissimilar materials to the thermoplastic substructure. This inhibits flush or near-flush repair for aerodynamic surfaces.

One repair process utilizes a thermoset repair patch that is secondarily bonded to the thermoplastic structure after extensive surface preparation. The extensive surface preparations can comprise sanding and plasma heating. The extensive surface preparations are undesirably difficult to perform and undesirably time consuming. The process controls for the surface preparation are very difficult to implement in the operational field. Curing the thermoset repair patch takes an undesirable amount of time and skilled operation. A resulting repair is dependent upon the surface preparations and cure of the thermoset patch.

Another existing solution is the bolted repair of an area. However, bolted repair generally does not result in an aerodynamic surface for external surface repair.

Therefore, it would be desirable to have a method and apparatus that takes into account at least some of the issues discussed above, as well as other possible issues.

### SUMMARY

An embodiment of the present disclosure provides a thermoplastic part with a thermoplastic repair patch. The thermoplastic part with a thermoplastic repair patch comprises a composite material with a cut-out forming a repair area, and the thermoplastic repair patch in the cut-out. The composite material has a first melting temperature. The thermoplastic repair patch comprises a plurality of consolidated thermoplastic stacks, each consolidated thermoplastic stack comprising thermoplastic composite plies between low melt thermoplastic surfaces having a second melting temperature lower than the first melting temperature.

An embodiment of the present disclosure provides a method of repairing a thermoplastic part. A low melt thermoplastic film is placed onto a repair area of a thermoplastic part. A plurality of consolidated thermoplastic stacks is placed over the low melt thermoplastic film to form a thermoplastic repair patch. The thermoplastic repair patch is heated to a processing temperature below a melting temperature of the thermoplastic part.

Another embodiment of the present disclosure provides a method of repairing a thermoplastic part. A low melt thermoplastic film is placed onto a repair area of a thermoplastic part. A first consolidated thermoplastic stack is placed over the low melt thermoplastic film. The first consolidated thermoplastic stack is heated to a processing temperature below a melting temperature of the thermoplastic part. A second consolidated thermoplastic stack is placed over the low melt thermoplastic film. The second consolidated thermoplastic stack is heated to the processing temperature to form a thermoplastic repair patch in the repair area.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of an aircraft in accordance with an illustrative embodiment;

FIG. 2 is an illustration of a block diagram of a manufacturing environment in accordance with an illustrative embodiment;

FIG. 3 is an illustration of a cross-sectional view of a thermoplastic repair patch being applied to a thermoplastic part in accordance with an illustrative embodiment;

FIG. 4 is an illustration of a cross-sectional view of a consolidated thermoplastic stack for a thermoplastic repair patch in accordance with an illustrative embodiment;

FIG. 5 is a flowchart of a method of repairing a thermoplastic part in accordance with an illustrative embodiment;

FIG. 6 is a flowchart of a method of repairing a thermoplastic part in accordance with an illustrative embodiment;

FIG. 7 is an illustration of an aircraft manufacturing and service method in a form of a block diagram in accordance with an illustrative embodiment ; and

FIG. 8 is an illustration of an aircraft in a form of a block diagram in which an illustrative embodiment may be implemented.

### DETAILED DESCRIPTION

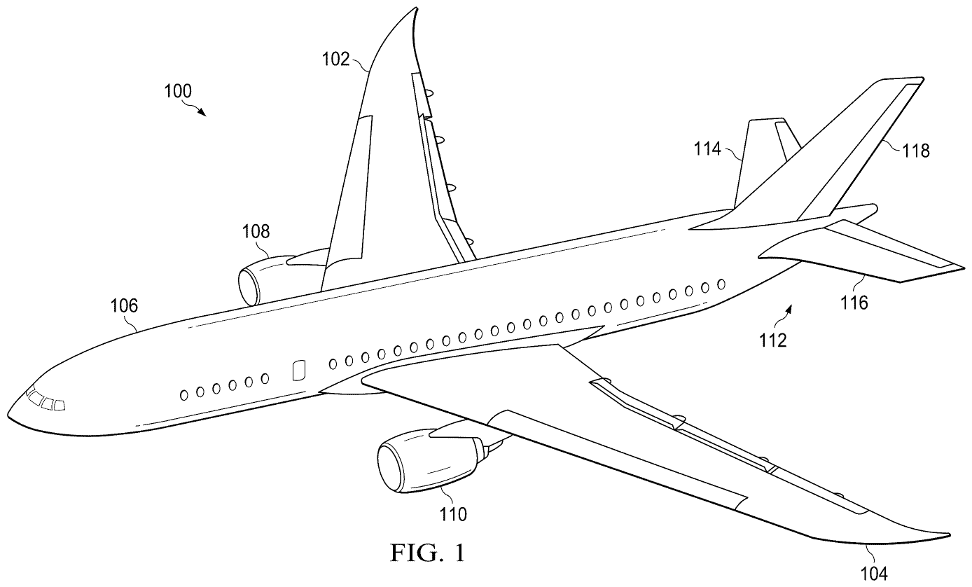

Turning now to FIG. 1, an illustration of an aircraft is depicted in accordance with an illustrative embodiment. Aircraft 100 has wing 102 and wing 104 attached to body 106. Aircraft 100 includes engine 108 attached to wing 102 and engine 110 attached to wing 104.

Body 106 has tail section 112. Horizontal stabilizer 114, horizontal stabilizer 116, and vertical stabilizer 118 are attached to tail section 112 of body 106.

Aircraft 100 is an example of an aircraft that can have thermoplastic parts repaired using a thermoplastic repair patch of the illustrative examples. A thermoplastic repair patch can be used to repair a thermoplastic part of aircraft 100 during maintenance.

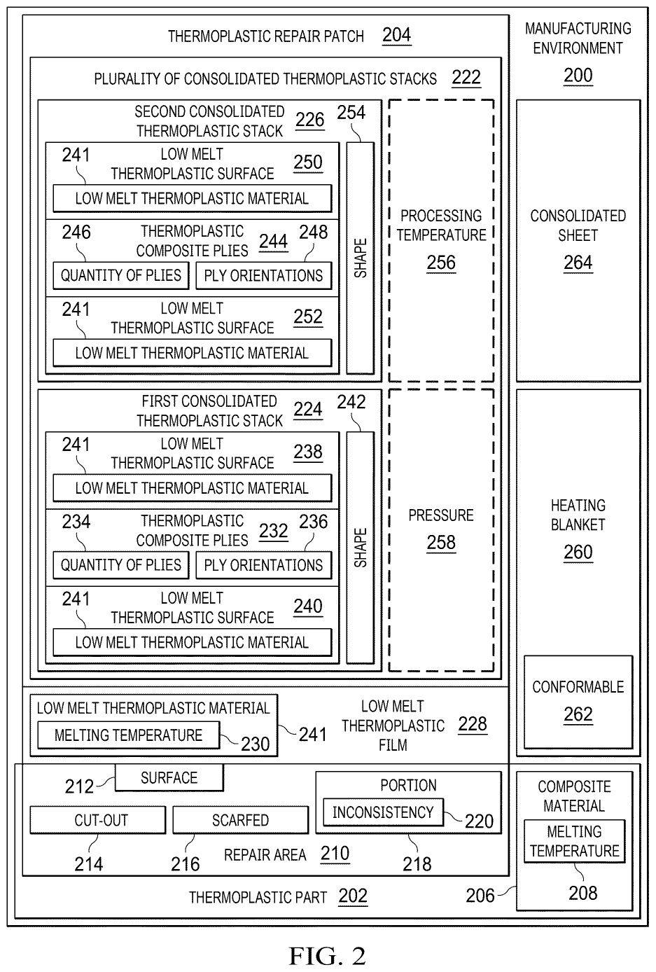

Turning now to FIG. 2, an illustration of a block diagram of a manufacturing environment is depicted in accordance with an illustrative embodiment. Thermoplastic part 202 with thermoplastic repair patch 204 is present in manufacturing environment 200. Thermoplastic part 202 comprises composite material 206 with cut-out 214 forming repair area 210. Composite material 206 has a first melting temperature, melting temperature 208. In some illustrative examples, melting temperature 208 is greater than 340 degrees Celsius.

Thermoplastic repair patch 204 in cut-out 214 comprises plurality of consolidated thermoplastic stacks 222. Each consolidated thermoplastic stack of plurality of consolidated thermoplastic stacks 222 comprises thermoplastic composite plies between low melt thermoplastic surfaces having a second melting temperature lower than the first melting temperature.

Plurality of consolidated thermoplastic stacks 222 comprises any desirable quantity of consolidated thermoplastic stacks. In this illustrative example, plurality of consolidated thermoplastic stacks 222 comprises two consolidated thermoplastic stacks. Plurality of consolidated thermoplastic stacks 222 comprises first consolidated thermoplastic stack 224 and second consolidated thermoplastic stack 226.

First consolidated thermoplastic stack 224 comprises thermoplastic composite plies 232 between low melt thermoplastic surfaces, low melt thermoplastic surface 238 and low melt thermoplastic surface 240, having a second melting temperature lower than the first melting temperature. In this illustrative example, low melt thermoplastic surface 238 and low melt thermoplastic surface 240 are formed of low melt thermoplastic material 241 having melting temperature 230. Melting temperature 230 can be referred to as the second melting temperature. In some illustrative examples, melting temperature 230 is between 260 degrees Celsius and 335 degrees Celsius.

Second consolidated thermoplastic stack 226 comprises thermoplastic composite plies 244 between low melt thermoplastic surfaces, low melt thermoplastic surface 250 and low melt thermoplastic surface 252, having a second melting temperature lower than the first melting temperature. In this illustrative example, low melt thermoplastic surface 250 and low melt thermoplastic surface 252 are formed of low melt thermoplastic material 241 having melting temperature 230.

Second consolidated thermoplastic stack 226 is placed on top of first consolidated thermoplastic stack 224 so that first consolidated thermoplastic stack 224 and second consolidated thermoplastic stack 226 are consecutive in a direction through the thickness of thermoplastic part 202. In this illustrative example, first consolidated thermoplastic stack 224 is placed into repair area 210 first.

In some illustrative examples, low melt thermoplastic film 228 is placed into repair area 210 and heated to processing temperature 256 to bond low melt thermoplastic film 228 to thermoplastic part 202.

In some illustrative examples, repair area 210 is created by removing inconsistency 220 from thermoplastic part 202. In some illustrative examples, repair area 210 comprises surface 212 of thermoplastic part 202 in cut-out 214 formed by removing inconsistency 220 from thermoplastic part 202.

In some illustrative examples, repair area 210 comprises portion 218 of thermoplastic part 202 after inconsistency 220 has been removed from thermoplastic part 202. In some illustrative examples, a series of layers of composite material have been cut away from thermoplastic part 202 to create repair area 210.

Repair area 210 can have any desirable size or shape. In some illustrative examples, repair area 210 is scarfed 216.

Thermoplastic composite plies of thermoplastic repair patch 204 are already consolidated. In some illustrative examples, thermoplastic composite plies of thermoplastic repair patch 204 are the same material as thermoplastic part 202. Heating blanket 260 is heated to heat thermoplastic repair patch 204 to processing temperature 256. Processing temperature 256 is selected to be below melting temperature 208 of thermoplastic part 202. Processing temperature 256 is selected such that thermoplastic composite plies of thermoplastic repair patch 204 remain consolidated. Processing temperature 256 is selected to melt low melt thermoplastic material 241. In some illustrative examples, processing temperature 256 is approximately 280° C.-340°C.

In some illustrative examples, heating blanket 260 is sufficiently conformable 262 to conform to thermoplastic repair patch 204 on thermoplastic part 202. In some illustrative examples, heating blanket 260 is sufficiently conformable 262 to conform to cut-out 214. In some illustrative examples, heating blanket 260 is sufficiently conformable 262 to conform to first consolidated thermoplastic stack 224 in cut-out 214.

During heating of thermoplastic repair patch 204, pressure 258 is applied to thermoplastic repair patch 204 to adhere thermoplastic repair patch 204. In some illustrative examples, pressure 258 below 15 psi is applied to thermoplastic repair patch 204 while heating thermoplastic repair patch 204 to join thermoplastic repair patch 204 to thermoplastic part 202.

Low melt thermoplastic film 228 is between thermoplastic repair patch 204 and repair area 210. Low melt thermoplastic film 228 comprises low melt thermoplastic material 241 having melting temperature 230.

Plurality of consolidated thermoplastic stacks 222 is joined by the low melt thermoplastic surfaces. First consolidated thermoplastic stack 224 is joined to thermoplastic part 202 by low melt thermoplastic film 228 and low melt thermoplastic surface 240. By heating low melt thermoplastic material 241 to processing temperature 256 and applying pressure 258, low melt thermoplastic surface 240 and low melt thermoplastic film 228 are joined.

Second consolidated thermoplastic stack 226 is joined to first consolidated thermoplastic stack 224 by low melt thermoplastic surface 238 and low melt thermoplastic surface 252. By heating low melt thermoplastic material 241 to processing temperature 256 and applying pressure 258, low melt thermoplastic surface 238 and low melt thermoplastic surface 252 are joined.

Thermoplastic composite plies 232 of first consolidated thermoplastic stack 224 comprises quantity of plies 234 and ply orientations 236. Ply orientations 236 comprises any desirable fiber angles. In some illustrative examples, ply orientations 236 can be selected from at least one of 0 degrees, 90 degrees, +/−45 degrees, +/−30 degrees, or +/−60 degrees. In some illustrative examples, ply orientations 236 are selected to approximate ply orientations of plies of thermoplastic part 202 that were removed from cut-out 214. Quantity of plies 234 can comprise any desirable quantity of plies.

In some illustrative examples, quantity of plies 234 comprises between two and six plies.

First consolidated thermoplastic stack 224 has shape 242. Shape 242 is selected to fill a portion of cut-out 214. When cut-out 214 is scarfed 216, shape 242 of first consolidated thermoplastic stack 224 is different from shape 254 of second consolidated thermoplastic stack 226.

In some illustrative examples, shape 242 of first consolidated thermoplastic stack 224 can be cut out from a consolidated sheet, such as consolidated sheet 264. Consolidated sheet 264 comprises a plurality of thermoplastic composite plies between two low melt thermoplastic surfaces. A plurality of different shapes can be cut from consolidated sheet 264 to form consolidated thermoplastic stacks for repair. In some other illustrative examples, shape 242 of first consolidated thermoplastic stack 224 can be laid up individually.

Thermoplastic composite plies 244 of second consolidated thermoplastic stack 226 comprises quantity of plies 246 and ply orientations 248. Ply orientations 248 comprises any desirable fiber angles. In some illustrative examples, ply orientations 248 can be selected from at least one of 0 degrees, 90 degrees, +/−45 degrees, +/−30 degrees, or +/−60 degrees. In some illustrative examples, ply orientations 248 are selected to approximate ply orientations of plies of thermoplastic part 202 that were removed from cut-out 214. Quantity of plies 246 can comprise any desirable quantity of plies. In some illustrative examples, quantity of plies 246 comprises between two and six plies.

In some illustrative examples, shape 254 of second consolidated thermoplastic stack 226 can be cut out from a consolidated sheet, such as consolidated sheet 264. In some illustrative examples, ply orientations 248 are the same as ply orientations 236 and quantity of plies 246 is the same as quantity of plies 234. In these illustrative examples, second consolidated thermoplastic stack 226 and first consolidated thermoplastic stack 224 can both be cut from consolidated sheet 264. In other illustrative examples, first consolidated thermoplastic stack 224 and second consolidated thermoplastic stack 226 are cut from two different consolidated sheets. In some other illustrative examples, shape 254 of second consolidated thermoplastic stack 226 can be laid up individually.

In some illustrative examples, low melt thermoplastic film 228 and plurality of consolidated thermoplastic stacks 222 are joined to thermoplastic part 202 simultaneously. In some illustrative examples, low melt thermoplastic film 228 and plurality of consolidated thermoplastic stacks 222 are all placed into cut-out 214 prior to applying processing temperature 256 and pressure 258. In some illustrative examples, processing temperature 256 and pressure 258 are applied to low melt thermoplastic film 228 in cut-out 214 prior to applying any of plurality of consolidated thermoplastic stacks 222 to cut-out 214.

In some illustrative examples, processing temperature 256 and pressure 258 are applied to low melt thermoplastic film 228 in cut-out 214 prior to applying first consolidated thermoplastic stack 224 to cut-out 214. In some illustrative examples, processing temperature 256 and pressure 258 are applied to first consolidated thermoplastic stack 224 in cut-out 214 prior to applying second consolidated thermoplastic stack 226 over first consolidated thermoplastic stack 224. In some illustrative examples, processing temperature 256 and pressure 258 is repeatedly applied to materials in repair area 210 until all portions of thermoplastic repair patch 204 have been applied and processed.

The illustration of manufacturing environment 200 in FIG. 2 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, although only two consolidated thermoplastic stacks are depicted in thermoplastic repair patch 204, more than two consolidated thermoplastic stacks can be present in a thermoplastic repair patch. Although each of the low melt thermoplastic surfaces and low melt thermoplastic film 228 all comprise low melt thermoplastic material 241, in some non-depicted examples more than one type of thermoplastic material can be present in a thermoplastic repair patch and low melt thermoplastic film. Additionally, in some illustrative examples, at least one of quantity of plies 246 or quantity of plies 234 comprises a single ply.

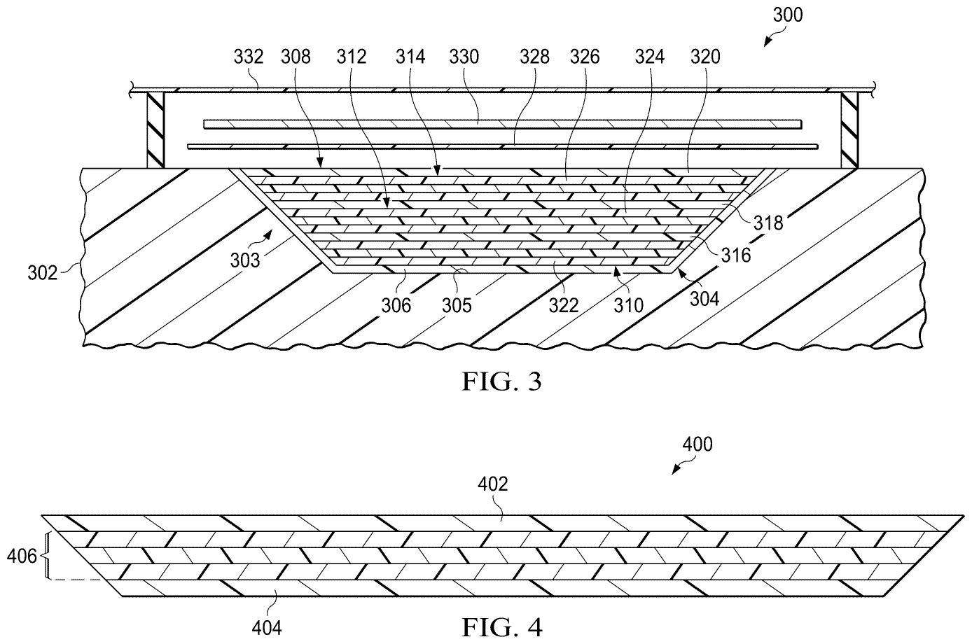

Turning now to FIG. 3, an illustration of a cross-sectional view of a thermoplastic repair patch being applied to a thermoplastic part is depicted in accordance with an illustrative embodiment. View 300 can be a view of repairing a thermoplastic part of aircraft 100 of FIG. 1. View 300 can be a view of repairing thermoplastic part 202 using thermoplastic repair patch 204 of FIG. 2.

In view 300, thermoplastic repair patch 304 is present in cut-out 305 of repair area 303 of thermoplastic part 302. Low melt thermoplastic film 306 is present between thermoplastic repair patch 304 and repair area 303. Thermoplastic repair patch 304 in cut-out 305 comprises plurality of consolidated thermoplastic stacks 308. Each consolidated thermoplastic stack comprises thermoplastic composite plies between low melt thermoplastic surfaces.

In this illustrative example, plurality of consolidated thermoplastic stacks 308 comprises consolidated thermoplastic stack 310, consolidated thermoplastic stack 312, and consolidated thermoplastic stack 314. Consolidated thermoplastic stack 310 comprises thermoplastic composite plies 322 between low melt thermoplastic surfaces. Consolidated thermoplastic stack 310 comprises a low melt thermoplastic surface in contact with low melt thermoplastic film 306. Consolidated thermoplastic stack 310 comprises a low melt thermoplastic surface forming part of low melt thermoplastic material 316.

Consolidated thermoplastic stack 312 comprises thermoplastic composite plies 324 between low melt thermoplastic surfaces. Consolidated thermoplastic stack 312 comprises a low melt thermoplastic surface forming part of low melt thermoplastic material 316.

Consolidated thermoplastic stack 312 comprises a low melt thermoplastic surface forming part of low melt thermoplastic material 318.

Consolidated thermoplastic stack 314 comprises thermoplastic composite plies 326 between low melt thermoplastic surfaces. Consolidated thermoplastic stack 314 comprises a low melt thermoplastic surface forming part of low melt thermoplastic material 318. Consolidated thermoplastic stack 314 comprises a low melt thermoplastic surface forming low melt thermoplastic material 320.

In view 300, a processing temperature and pressure have been applied to thermoplastic repair patch 304. By applying the processing temperature, the low melt thermoplastic surfaces have been melted to join plurality of consolidated thermoplastic stacks 308. By applying the processing temperature, the low melt thermoplastic surfaces have been melted to form low melt thermoplastic material 316, low melt thermoplastic material 318, and low melt thermoplastic material 320.

The processing temperature is applied to thermoplastic repair patch 304 by heating blanket 330. Release film 328 is positioned between thermoplastic repair patch 304 and heating blanket 330. In this illustrative example, vacuum bag 332 is sealed around repair area 303 for repair processing.

The illustration of applying thermoplastic repair patch 304 in FIG. 3 is not meant to imply physical or architectural limitations to the manner in which an illustrative embodiment may be implemented. Other components in addition to or in place of the ones illustrated may be used. Some components may be unnecessary. For example, thermoplastic repair patch 304 can have any desirable quantity of consolidated thermoplastic stacks. Although three consolidated thermoplastic stacks are depicted, thermoplastic repair patch 304 can have greater than three or less than three consolidated thermoplastic stacks. Although a single heating blanket is depicted in FIG. 3, in some illustrative examples, heating blankets can be applied to both external surfaces of the repair area to get the desired heat profile into the areas of interest for film melt and consolidation.

Turning now to FIG. 4, an illustration of a cross-sectional view of a consolidated thermoplastic stack for a thermoplastic repair patch is depicted in accordance with an illustrative embodiment. Consolidated thermoplastic stack 400 can be used to repair a thermoplastic part of aircraft 100 of FIG. 1. Consolidated thermoplastic stack 400 is a physical implementation of one of plurality of consolidated thermoplastic stacks 222 of FIG. 2. Consolidated thermoplastic stack 400 can be a portion of thermoplastic repair patch 304 of FIG. 3.

Consolidated thermoplastic stack 400 comprises thermoplastic composite plies 406 between low melt thermoplastic surfaces. Thermoplastic composite plies 406 are between low melt thermoplastic surface 402 and low melt thermoplastic surface 404. Low melt thermoplastic surface 402 and low melt thermoplastic surface 404 are formed of a low melt thermoplastic film having a melting temperature below the melting temperature of thermoplastic composite plies 406. Low melt thermoplastic surface 402 and low melt thermoplastic surface 404 can be used to bond consolidated thermoplastic stack 400 to other consolidated thermoplastic stacks.

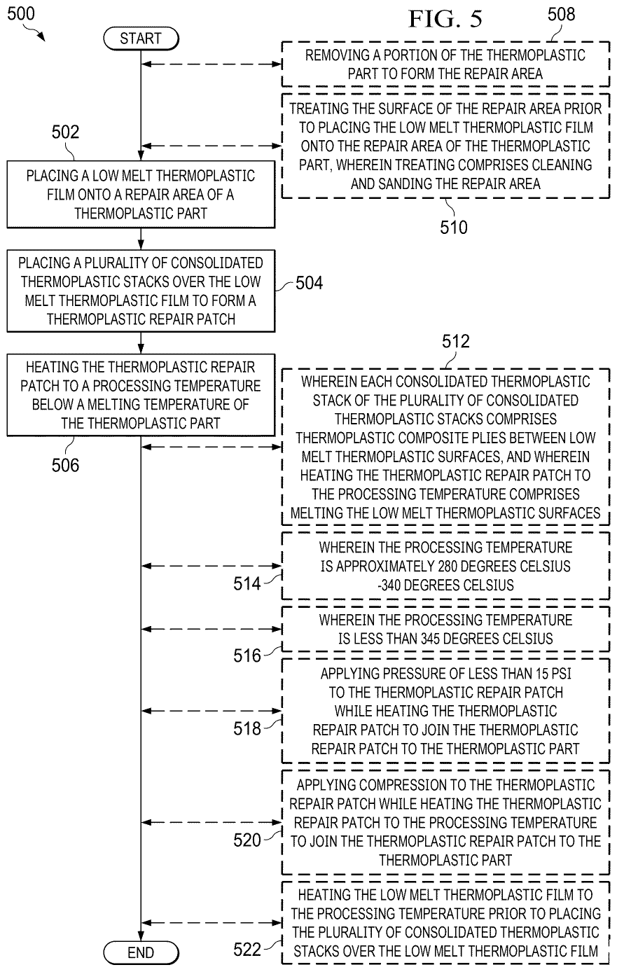

Turning now to FIG. 5, a flowchart of a method of repairing a thermoplastic part is depicted in accordance with an illustrative embodiment. Method 500 can be implemented to repair a thermoplastic part of aircraft 100 of FIG. 1. Method 500 can be implemented to repair thermoplastic part 202 using thermoplastic repair patch 204 of FIG. 2. Method 500 can be used to repair thermoplastic part 302 using thermoplastic repair patch 304 of FIG. 3. Consolidated thermoplastic stack 400 of FIG. 4 can be one of the plurality of consolidated thermoplastic stacks of method 500.

Method 500 places a low melt thermoplastic film onto a repair area of a thermoplastic part (operation 502). Method 500 places a plurality of consolidated thermoplastic stacks over the low melt thermoplastic film to form a thermoplastic repair patch (operation 504). Method 500 heats the thermoplastic repair patch to a processing temperature below a melting temperature of the thermoplastic part (operation 506). Afterwards, method 500 terminates.

In some illustrative examples, method 500 removes a portion of the thermoplastic part to form the repair area (operation 508). In some illustrative examples, the portion of the thermoplastic part removed comprises an inconsistency. In some illustrative examples, removing the inconsistency from the thermoplastic part comprises removing material to form a scarfed cut-out.

In some illustrative examples, method 500 treats a surface of the repair area prior to placing the low melt thermoplastic film onto the repair area of the thermoplastic part, wherein treating comprises cleaning and sanding the repair area (operation 510). In some illustrative examples, treating the surface of the thermoplastic part takes considerably less time, less energy, or is less complicated than treating a thermoplastic surface to join to a thermoset repair patch.

In some illustrative examples, each consolidated thermoplastic stack of the plurality of consolidated thermoplastic stacks comprises thermoplastic composite plies between low melt thermoplastic surfaces, and wherein heating the thermoplastic repair patch to the processing temperature comprises melting the low melt thermoplastic surfaces (operation 512). In these illustrative examples, melting the low melt thermoplastic surfaces joins the low melt thermoplastic surfaces together.

In some illustrative examples, the processing temperature is approximately 280 degrees Celsius-340 degrees Celsius (operation 514). In some illustrative examples, the processing temperature is less than 345 degrees Celsius (operation 516). The processing temperature is selected such that the thermoplastic part remains consolidated while the low melt thermoplastic material melts. The processing temperature is selected such that the consolidated thermoplastic composite plies remain consolidated.

In some illustrative examples, method 500 applies pressure of less than 15 psi to the thermoplastic repair patch while heating the thermoplastic repair patch to join the thermoplastic repair patch to the thermoplastic part (operation 518). In some illustrative examples, method 500 applies compression to the thermoplastic repair patch while heating the thermoplastic repair patch to the processing temperature to join the thermoplastic repair patch to the thermoplastic part (operation 520).

In some illustrative examples, method 500 heats the low melt thermoplastic film to the processing temperature prior to placing the plurality of consolidated thermoplastic stacks over the low melt thermoplastic film (operation 522). In some illustrative examples, the low melt thermoplastic film and the plurality of consolidated thermoplastic stacks are placed in the repair area prior to heating the low melt thermoplastic film to the processing temperature.

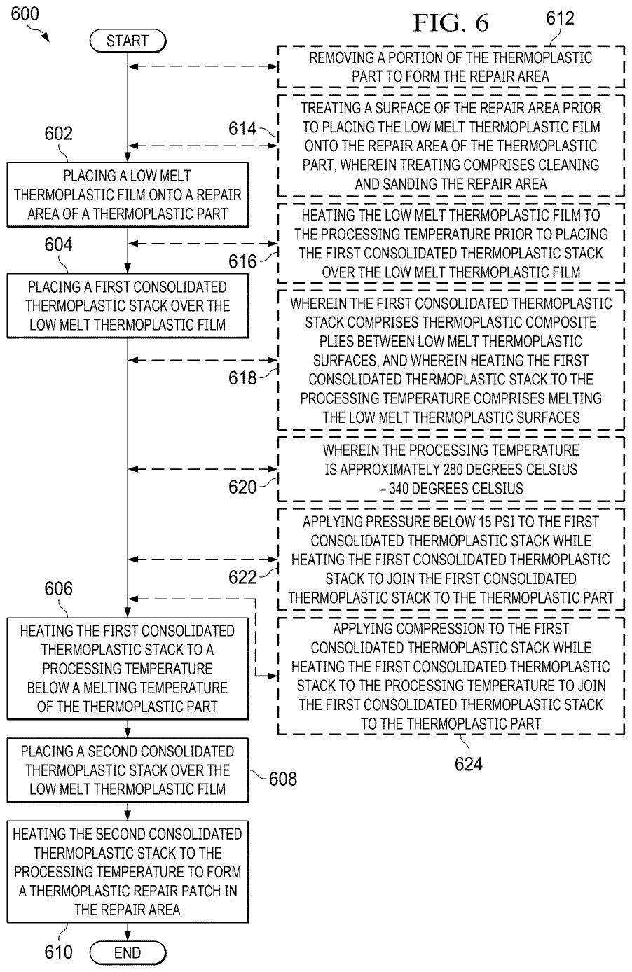

Turning now to FIG. 6, a flowchart of a method of repairing a thermoplastic part is depicted in accordance with an illustrative embodiment. Method 600 can be implemented to repair a thermoplastic part of aircraft 100 of FIG. 1. Method 600 can be implemented to repair thermoplastic part 202 using thermoplastic repair patch 204 of FIG. 2. Method 600 can be used to repair thermoplastic part 302 using thermoplastic repair patch 304 of FIG. 3. Consolidated thermoplastic stack 400 of FIG. 4 can be one of the plurality of consolidated thermoplastic stacks of method 600.

Method 600 places a low melt thermoplastic film onto a repair area of a thermoplastic part (operation 602). Method 600 places a first consolidated thermoplastic stack over the low melt thermoplastic film (operation 604). Method 600 heats the first consolidated thermoplastic stack to a processing temperature below a melting temperature of the thermoplastic part (operation 606). Method 600 places a second consolidated thermoplastic stack over the low melt thermoplastic film (operation 608). Method 600 heats the second consolidated thermoplastic stack to the processing temperature to form a thermoplastic repair patch in the repair area (operation 610). Afterwards, method 600 terminates.

In some illustrative examples, method 600 further comprises removing a portion of the thermoplastic part to form the repair area (operation 612). In some illustrative examples, method 600 further comprises treating a surface of the repair area prior to placing the low melt thermoplastic film onto the repair area of the thermoplastic part, wherein treating comprises cleaning and sanding the repair area (operation 614).

In some illustrative examples, method 600 further comprises heating the low melt thermoplastic film to the processing temperature prior to placing the first consolidated thermoplastic stack over the low melt thermoplastic film (operation 616). The processing temperature is selected such that the thermoplastic part remains consolidated while the low melt thermoplastic material melts.

In some illustrative examples, the first consolidated thermoplastic stack comprises thermoplastic composite plies between low melt thermoplastic surfaces, and wherein heating the first consolidated thermoplastic stack to the processing temperature comprises melting the low melt thermoplastic surfaces (operation 618). The processing temperature is selected such that the consolidated thermoplastic composite plies remain consolidated.

In some illustrative examples, the processing temperature is approximately 280 degrees celsius-340 degrees Celsius (operation 620). In some illustrative examples, method 600 further comprises applying pressure below 15 psi to the first consolidated thermoplastic stack while heating the first consolidated thermoplastic stack to join the first consolidated thermoplastic stack to the thermoplastic part (operation 622). In some illustrative examples, method 600 further comprises applying compression to the first consolidated thermoplastic stack while heating the first consolidated thermoplastic stack to the processing temperature to join the first consolidated thermoplastic stack to the thermoplastic part (operation 624).

As used herein, the phrase “at least one of,” when used with a list of items, means different combinations of one or more of the listed items may be used and only one of each item in the list may be needed. For example, “at least one of item A, item B, or item C” may include, without limitation, item A, item A and item B, or item B. This example also may include item A, item B, and item C, or item B and item C. Of course, any combinations of these items may be present. In other examples, “at least one of” may be, for example, without limitation, two of item A; one of item B; and ten of item C; four of item B and seven of item C; or other suitable combinations. The item may be a particular object, thing, or a category. In other words, at least one of means any combination items and number of items may be used from the list but not all of the items in the list are required.

As used herein, “a number of,” when used with reference to items means one or more items.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step.

In some alternative implementations of an illustrative embodiment, the function or functions noted in the blocks may occur out of the order noted in the figures. For example, in some cases, two blocks shown in succession may be executed substantially concurrently, or the blocks may sometimes be performed in the reverse order, depending upon the functionality involved. Also, other blocks may be added in addition to the illustrated blocks in a flowchart or block diagram. Some blocks may be optional. For example, operation 508 through operation 522 may be optional. As another example, operation 612 through operation 624 may be optional.

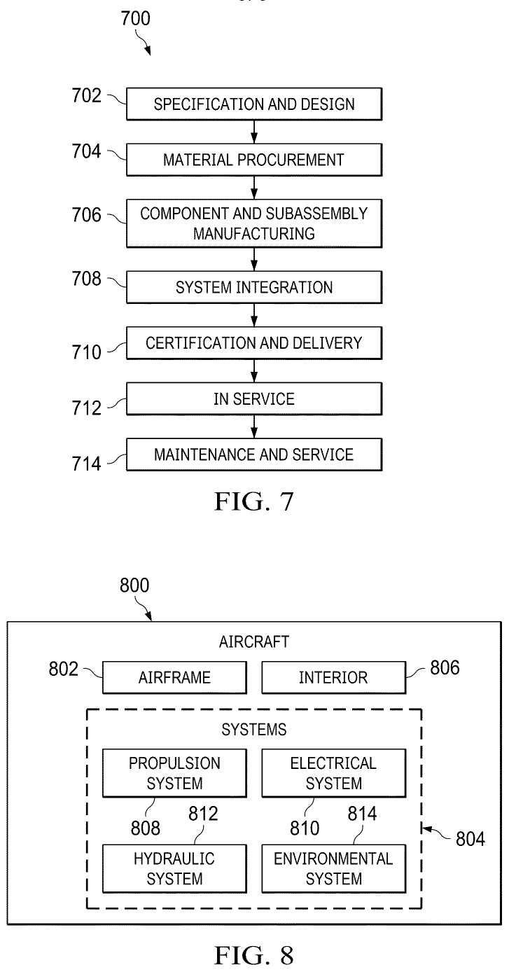

Illustrative embodiments of the present disclosure may be described in the context of aircraft manufacturing and service method 700 as shown in FIG. 7 and aircraft 800 as shown in FIG. 8. Turning first to FIG. 7, an illustration of an aircraft manufacturing and service method in a form of a block diagram is depicted in accordance with an illustrative embodiment. During pre-production, aircraft manufacturing and service method 700 may include specification and design 702 of aircraft 800 in FIG. 8 and material procurement 704.

During production, component and subassembly manufacturing 706 and system integration 708 of aircraft 800 takes place. Thereafter, aircraft 800 may go through certification and delivery 710 in order to be placed in service 712. While in service 712 by a customer, aircraft 800 is scheduled for routine maintenance and service 714, which may include modification, reconfiguration, refurbishment, or other maintenance and service.

Each of the processes of aircraft manufacturing and service method 700 may be performed or carried out by a system integrator, a third party, and/or an operator.

In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 8, an illustration of an aircraft in a form of a block diagram is depicted in which an illustrative embodiment may be implemented. In this example, aircraft 800 is produced by aircraft manufacturing and service method 700 of FIG. 7 and may include airframe 802 with plurality of systems 804 and interior 806. Examples of systems 804 include one or more of propulsion system 808, electrical system 810, hydraulic system 812, and environmental system 814. Any number of other systems may be included.

Apparatuses and methods embodied herein may be employed during at least one of the stages of aircraft manufacturing and service method 700. One or more illustrative embodiments may be manufactured or used during at least one of component and subassembly manufacturing 706, system integration 708, in service 712, or maintenance and service 714 of FIG. 7.

The illustrative examples present a thermoplastic repair patch with low-melt thermoplastic film. The use of low-melt thermoplastic film enables thermoplastic co-melting to the structure to be repaired. The illustrative examples enables a lower temperature and lower pressure processing of the patch to the material enables. The illustrative examples enable less tooling and less heat to be applied when compared to a repair conducted with higher temperature thermoplastic materials.

The illustrative examples enable greater structural and processing robustness in the repair, when compared to thermoset repair materials. The illustrative examples utilize less complicated surface preparations than thermoset patches for repairing the thermoplastic part. Thermoplastic processing and joining is far less sensitive to surface preparation and other boundary conditions than thermoset repair processing methods.

The illustrative examples provide repair for the thermoplastic part with a reduced repair time compared to using thermoset patches. The time for thermoplastic processing is a fraction of the time for thermoset processing.

The choice of formulation of the low-melt thermoplastic film is compatible with the base structural thermoplastic material. The low-melt thermoplastic film in the illustrative examples enables co-melt to join structurally and chemically at a lower temperature and pressure than for the processing of the base structural material. In the illustrative examples, the structural material does not soften or deconsolidate during the repair processing.

In the illustrative examples, the base thermoplastic material is a high-temperature melt/consolidation. In some illustrative examples, the high temperature melt/consolidation for the base thermoplastic material is 380 degrees Celsius and above. The illustrative examples provide a thermoplastic film of melt-temperature 260 degrees Celsius-335 degrees Celsius to join the base high temperature thermoplastics.

The illustrative examples present a method comprising performing a heat/pressure process that creates a co-cure/co-melt structure between the base and low-melt thermoplastic materials. In some illustrative examples, the heat/pressure process comprises applying a temperature below 345 degrees Celsius. In some illustrative examples, the heat/pressure process comprises applying a pressure of less than 15 psi.

The illustrative examples utilize an external heat source. In some illustrative examples, the external heat source is a heating blanket that conforms to the surface of the structure to be repaired, including the repair scarf profile.

A first low-temp thermoplastic film layer is joined to the substructure/base thermoplastic material. The scarfed void can be filled with thermoplastic materials. The filler materials are made of unique plies which have been pre-fabricated for this purpose. Each unique repair filler ply is a sandwich of low-temp film, base thermoplastic material, and low-temp film. The thermoplastic base material which forms the center of the sandwich can be a single unidirectional ply or can be made up of 2-6 plies of varying orientations. One example of thermoplastic composite plies can be three thermoplastic layers having a 45/0/−45 orientation. The thermoplastic composite plies can comprise any desirable quantity of plies. A lower ply number can allow easier conformance at room temperature to the scarf profile to be filled.

In some illustrative examples, the filler materials are fabricated in large sheets, and the filler plies for the scarf void are cut from the sheets to fit the scarf pattern. The cut thermoplastic consolidated stacks are then applied to the void, and vacuum-bag pressure is applied. The heating blanket is then applied, and the patch is processed per the consolidation temperature profile of the low-melt thermoplastic film.

In some illustrative examples, depending on heat transfer characteristics of the applied environment, the patch may be heated/applied sequentially. In some illustrative examples, if the thermoplastic repair patch is too thick to transfer heat from the external heating blanket through the whole repair area to achieve the melt temperature, consolidated thermoplastic stacks can be applied and heated individually or in sets. In some illustrative examples, sets of consolidated thermoplastic stacks can be applied a smaller number of filler materials and heat, and repeat this stacking build-up until the repair is finished. After completion of the heat cycle, the repair area can be inspected.

The description of the different illustrative embodiments has been presented for purposes of illustration and description and is not intended to be exhaustive or limited to the embodiments in the form disclosed. Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

1. A thermoplastic part with a thermoplastic repair patch comprising:
a composite material with a cut-out forming a repair area, the composite material having a first melting temperature; and
the thermoplastic repair patch in the cut-out, the thermoplastic repair patch comprising a plurality of consolidated thermoplastic stacks, each consolidated thermoplastic stack comprising thermoplastic composite plies between low melt thermoplastic surfaces having a second melting temperature lower than the first melting temperature.

2. The thermoplastic part of claim 1 further comprising a low melt thermoplastic film between the thermoplastic repair patch and the repair area.

3. The thermoplastic part of claim 1, wherein the first melting temperature is greater than 340 degrees Celsius.

4. The thermoplastic part of claim 1, wherein the second melting temperature is between 260 degrees Celsius and 335 degrees Celsius.

5. The thermoplastic part of claim 1, wherein the plurality of consolidated thermoplastic stacks is joined by the low melt thermoplastic surfaces.

6. A method of repairing a thermoplastic part comprising:
placing a low melt thermoplastic film onto a repair area of a thermoplastic part;
placing a plurality of consolidated thermoplastic stacks over the low melt thermoplastic film to form a thermoplastic repair patch; and
heating the thermoplastic repair patch to a processing temperature below a melting temperature of the thermoplastic part.

7. The method of claim 6, wherein each consolidated thermoplastic stack of the plurality of consolidated thermoplastic stacks comprises thermoplastic composite plies between low melt thermoplastic surfaces, and wherein heating the thermoplastic repair patch to the processing temperature comprises melting the low melt thermoplastic surfaces.

8. The method of claim 6, wherein the processing temperature is approximately 280 degrees Celsius-340 degrees Celsius.

9. The method of claim 6 further comprising:
applying pressure below 15 psi to the thermoplastic repair patch while heating the thermoplastic repair patch to join the thermoplastic repair patch to the thermoplastic part.

10. The method of claim 6 further comprising:
applying compression to the thermoplastic repair patch while heating the thermoplastic repair patch to the processing temperature to join the thermoplastic repair patch to the thermoplastic part.

11. The method of claim 6 further comprising:
heating the low melt thermoplastic film to the processing temperature prior to placing the plurality of consolidated thermoplastic stacks over the low melt thermoplastic film.

12. The method of claim 6 further comprising:
removing a portion of the thermoplastic part to form the repair area.

13. The method of claim 12 further comprising:
treating a surface of the repair area prior to placing the low melt thermoplastic film onto the repair area of the thermoplastic part, wherein treating comprises cleaning and sanding the repair area.

14. A method of repairing a thermoplastic part comprising:
placing a low melt thermoplastic film onto a repair area of a thermoplastic part;
placing a first consolidated thermoplastic stack over the low melt thermoplastic film;
heating the first consolidated thermoplastic stack to a processing temperature below a melting temperature of the thermoplastic part;
placing a second consolidated thermoplastic stack over the low melt thermoplastic film; and
heating the second consolidated thermoplastic stack to the processing temperature to form a thermoplastic repair patch in the repair area.

15. The method of claim 14, wherein the first consolidated thermoplastic stack comprises thermoplastic composite plies between low melt thermoplastic surfaces, and wherein heating the first consolidated thermoplastic stack to the processing temperature comprises melting the low melt thermoplastic surfaces.

16. The method of claim 14, wherein the processing temperature is approximately 280 degrees Celsius-340 degrees Celsius.

17. The method of claim 14 further comprising:
applying pressure below 15 psi to the first consolidated thermoplastic stack while heating the first consolidated thermoplastic stack to join the first consolidated thermoplastic stack to the thermoplastic part.

18. (canceled)

19. The method of claim 14 further comprising:
heating the low melt thermoplastic film to the processing temperature prior to placing the first consolidated thermoplastic stack over the low melt thermoplastic film.

20. The method of claim 14 further comprising:
removing a portion of the thermoplastic part to form the repair area.

21. The method of claim 20 further comprising:
treating a surface of the repair area prior to placing the low melt thermoplastic film onto the repair area of the thermoplastic part, wherein treating comprises cleaning and sanding the repair area.
